(19) United States
(12) Patent Application Publication
(10) Pub. No.: US 2017/0277304 A1
(43) Pub. Date: Sep. 28, 2017

(54) Pressure Detection Device, Grating, Display Device and Display Method Thereof

(71) Applicants: BOE Technology Group Co., Ltd., Beijing (CN); Beijing BOE Optoelectronics Technology Co., Ltd., Beijing (CN)

(72) Inventors: Changfeng Li, Beijing (CN); Xiaochuan Chen, Beijing (CN); Haisheng Wang, Beijing (CN); Xiaoliang Ding, Beijing (CN); Hongjuan Liu, Beijing (CN); Shengji Yang, Beijing (CN); Yingming Liu, Beijing (CN); Pengpeng Wang, Beijing (CN); Pengcheng Lu, Beijing (CN)

(73) Assignees: BOE Technology Group Co., Ltd., Beijing (CN); Beijing BOE Optoelectronics Technology Co., Ltd., Beijing (CN)

(21) Appl. No.: 15/504,393

(22) PCT Filed: Jun. 3, 2016
(86) PCT No.: PCT/CN2016/084758

§ 371 Date: Feb. 16, 2017

(30) Foreign Application Priority Data
Oct. 30, 2015 (CN) 201510729202.4

(51) Int. Cl. G06F 3/044; G02F 1/1333; G06F 3/16; G02B 27/22; G09G 3/36; G01L 1/14; G02F 1/1343

(52) U.S. Cl. CPC G06F 3/044; G01L 1/146; G02F 1/13338; G02F 1/134336; G02F 1/133345; G02B 27/22; G09G 3/36; G06F 3/165; G06F 2203/04111; G09G 2320/06

(57) ABSTRACT

A pressure detection device, a grating, a display device and a display method thereof, which can improve user experience. The pressure detection device includes: a capacitance detection module, a first electrode, a second electrode and an insulating layer; the insulating layer is made from an elastic material and disposed between the first electrode and the second electrode; the first electrode and the second electrode are at least partially overlapped; and the capacitance detection module is respectively connected with the first electrode and the second electrode and configured to detect capacitance between the first electrode and the second electrode.

### TECHNICAL FIELD

Embodiments of the present disclosure relate to a pressure detection device, a grating, a display device and a display method thereof.

### BACKGROUND

In recent years, three-dimensional (3D) displays have become a development trend in the display field. Compared with normal 2D displays, the 3D display technology allows a frame to be stereo and realistic, and images are no longer limited to the screen plane, as if displayed outside the screen, so that the audience can have an immersed sense.

The current 3D display technology only allows users to “view”, but operations of the user cannot be immersed in display, which is a disadvantage of 3D display.

### SUMMARY

Embodiments of the present disclosure provide a pressure detection device, a grating, a display device and a display method thereof. The pressure detection device can detect the pressure applied by a user and improve user experience by changing display settings according to the pressure.

For example, an embodiment of the present disclosure provides a pressure detection device, comprising: a capacitance detection module, a first electrode, a second electrode and an insulating layer; the insulating layer is made from an elastic material and disposed between the first electrode and the second electrode; the first electrode and the second electrode are at least partially overlapped; and the capacitance detection module is respectively connected with the first electrode and the second electrode and configured to detect capacitance between the first electrode and the second electrode.

For example, the first electrode and the second electrode are overlapped at a plurality of overlapping sections, and the overlapping sections are arranged in a matrix.

For example, the first electrode includes a plurality of block electrodes arranged in a matrix and insulated from each other, and the second electrode is a planar electrode and corresponds to the first electrode; or the second electrode includes a plurality of block electrodes arranged in a matrix and insulated from each other, and the first electrode is a planar electrode and corresponds to the second electrode; or the first electrode includes a plurality of strip electrodes arranged in parallel to each other; the second electrode includes a plurality of strip electrodes arranged in parallel to each other; and the plurality of strip electrodes in the first electrode and the plurality of strip electrodes in the second electrodes are partially overlapped.

For example, the insulating layer includes a plurality of insulating patterns separate from each other; and the insulating patterns are disposed at the overlapping sections of the first electrode and the second electrode.

An embodiment of the present disclosure provides a grating, which comprises the pressure detection device according to any one embodiment of the present disclosure.

For example, the grating further comprises: a base substrate provided with grating fringes; the pressure detection device is disposed on the base substrate and disposed on a same side of the base substrate as the grating fringes or on a different side of the base substrate from the grating fringes.

For example, the grating further comprises a grating box; the pressure detection device is disposed on the grating box.

For example, the grating box includes: a first substrate and a second substrate which are cell-assembled; the first electrode, the insulating layer and the second electrode are disposed on one side of the first substrate away from the second substrate; a third electrode is disposed on one side of the first substrate close to the second substrate; a fourth electrode is disposed on one side of the second substrate close to the first substrate; and the grating is formed by the third electrode and the fourth electrode.

For example, the grating box includes: a first substrate and a second substrate which are cell-assembled; the first electrode and the insulating layer are disposed on one side of the first substrate away from the second substrate; the second electrode is disposed on one side of the first substrate close to the second substrate; a fourth electrode is disposed on one side of the second substrate close to the first substrate; and the grating is formed by the second electrode and the fourth electrode.

For example, the second electrode is a strip electrode, and the fourth electrode is a planar electrode and corresponds to the plurality of second electrodes; or the second electrode is a strip electrode, the fourth electrode being a strip electrode, the second electrode corresponding to the fourth electrode; or the second electrode is a planar electrode, the fourth electrode being a strip electrode, the second electrode corresponding to the plurality of fourth electrodes.

An embodiment of the present disclosure provides a display device, comprising a display panel and the grating according to any one embodiment of the present disclosure disposed on a light-emitting side of the display panel.

An embodiment of the present disclosure provides a display method of a display device, comprising: acquiring a touch position and capacitance between a first electrode and a second electrode detected by a capacitance detection module; and adjusting a display parameter of the display device and/or a sound volume of the display device according to the capacitance and the touch position.

For example, in a process of forming a touch path, the capacitance between the first electrode and the second electrode at each touch position on the touch path is acquired, and a pen size corresponding to the touch position is adjusted according to the capacitance at the touch position.

Embodiments of the present disclosure provide a pressure detection device, a grating, a display device and a display method thereof. An insulting elastic material layer is disposed between a first electrode and a second electrode; elastic materials are deformed when applied by pressure, so that the distance between the first electrode and the second electrode can be reduced; when the pressure is higher, the distance between the first electrode and the second electrode is smaller and the capacitance is larger; and when the pressure is lower, the distance between the first electrode and the second electrode is larger and the capacitance is smaller, so that the pressure can be determined by detecting the capacitance.

### BRIEF DESCRIPTION OF THE DRAWINGS

In order to clearly illustrate the technical solution of the embodiments of the disclosure, the drawings of the embodiments will be briefly described in the following; it is obvious that the described drawings are only related to some embodiments of the disclosure and thus are not limitative of the disclosure. For those skilled in the related art, other drawings can be obtained based on these drawings without inventive work.

FIG. 1 is a schematic sectional view of a pressure detection device provided by an embodiment of the present disclosure;

FIG. 2 is a schematic diagram of an electrode structure of the pressure detection device provided by an embodiment of the present disclosure;

FIG. 3 is a schematic diagram of another electrode structure of the pressure detection device provided by an embodiment of the present disclosure;

FIG. 4 is a schematic sectional view of another pressure detection device provided by an embodiment of the present disclosure;

FIG. 5 is a schematic sectional view of a grating provided by an embodiment of the present disclosure;

FIG. 6 is a schematic sectional view of another grating provided by an embodiment of the present disclosure;

FIG. 7A is a schematic sectional view of still another grating provided by an embodiment of the present disclosure;

FIG. 7B is a schematic sectional view of still another grating provided by an embodiment of the present disclosure;

FIG. 8 is a schematic diagram of a display device provided by an embodiment of the present disclosure;

FIG. 9 is a schematic diagram illustrating the variation of pen size along with pressure in an embodiment of the present disclosure; and

FIG. 10 is another schematic diagram illustrating the variation of pen size along with pressure in an embodiment of the present disclosure.

Reference numerals of the accompanying drawings:

10—base substrate; 11—first electrode; 12—second electrode; 13—insulating layer; 14—capacitance detection module; 21—first substrate; 22—second substrate; 30—liquid crystal; 31—third electrode; 41—fourth electrode; 50—grating fringe; 100—pressure detection device; 131—insulating pattern; 200—grating box; 300—grating; 300′—grating; 400—display device; 500—display panel.

### DETAILED DESCRIPTION

In order to make objects, technical details and advantages of the embodiments of the disclosure apparent, the technical solutions of the embodiments will be described in a clearly and fully understandable way in connection with the drawings related to the embodiments of the disclosure. Apparently, the described embodiments are just a part but not all of the embodiments of the disclosure. Based on the described embodiments herein, those skilled in the art can obtain other embodiment(s), without any inventive work, which should be within the scope of the disclosure.

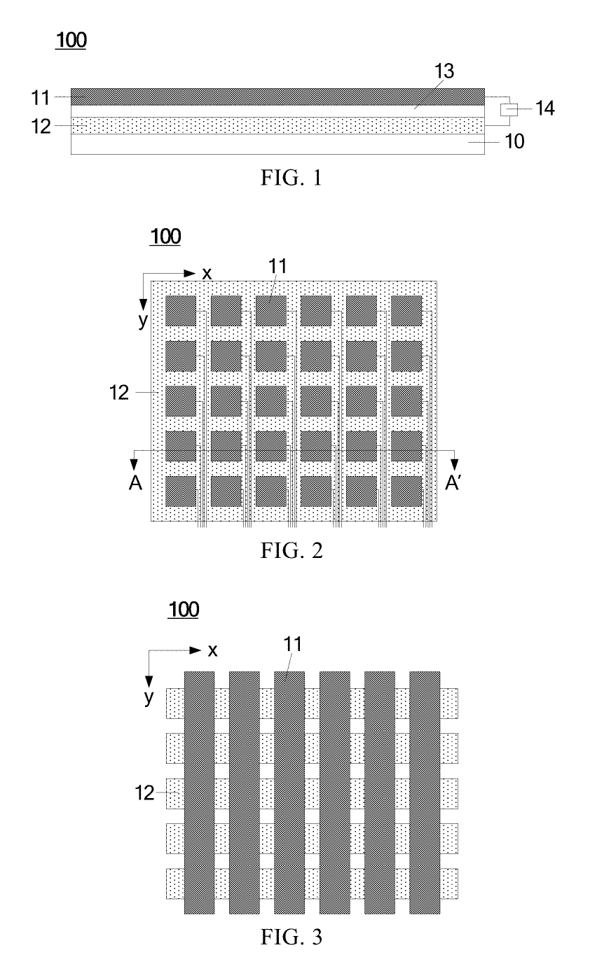

An embodiment of the present disclosure provides a pressure detection device 100, which, as illustrated FIG. 1, comprises: a capacitance detection module 14 and a first electrode 11, a second electrode 12 and an insulating layer 13 disposed on a base substrate 10, wherein the insulating layer 13 is made from an elastic material and disposed between the first electrode 11 and the second electrode 12; the position of the first electrode 11 is opposite to that of the second electrode 12, namely the first electrode 11 and the second electrode 12 are overlapped with each other; and the capacitance detection module 14 is respectively connected with the first electrode 11 and the second electrode 12 and is configured to detect the capacitance between the first electrode 11 and the second electrode 12. Description is given in FIG. 1 by taking the case that the first electrode 11, the second electrode 12 and the insulating layer 13 are disposed on the base substrate 10 as an example.

It should be noted that the insulating layer is made from an elastic material, namely the insulating layer can be deformed (for instance, the thickness is reduced) under the action of pressure and can be restored to the original shape after the removal of the pressure. For instance, the insulating layer may be a polyethylene terephthalate (PET) film. As known from a computing formula of capacitance, the capacitance between the first electrode and the second electrode is inversely proportional to the distance between the first electrode and the second electrode. Thus, when the pressure is higher, the deformation of the insulating layer is larger, the distance between the first electrode and the second electrode is smaller, and the capacitance between the first electrode and the second electrode is larger. Vice versa, when the pressure is lower, the deformation of the insulating layer is smaller, the distance between the first electrode and the second electrode is larger, and the capacitance between the first electrode and the second electrode is smaller. The capacitance detection module detects the capacitance between the first electrode and the second electrode. Thus, the capacitance may reflect the pressure, namely the pressure variation can be detected.

For instance, in the embodiment of the present disclosure, the capacitance detection module is respectively connected with the first electrode and the second electrode through connecting lines. No specific limitation will be given to the position of the capacitance detection module in the embodiment of the present disclosure. For instance, as illustrated in FIG. 1, the first electrode 11, the second electrode 12 and the insulating layer 13 are disposed on the same side of the base substrate 10, and the capacitance detection module 14 may be disposed on the other side of the base substrate 10 and is respectively connected with the first electrode 11 and the second electrode 12. Or the pressure detection device further comprises a circuit bonding pad. The circuit bonding pad is special for bonding a circuit board or the like, and the capacitance detection module is disposed on the circuit bonding pad. The capacitance detection module may be a capacitance detection circuit and may include elements such as a transistor, an amplifier, a resistor or the like. For instance, the capacitance detection circuit inputs an actuating signal into a capacitor to be detected, measures the voltage variation of the capacitor to be detected, and hence detects the capacitance of the capacitor to be detected.

An embodiment of the present disclosure provides a pressure detection device. An insulting elastic material layer is disposed between a first electrode and a second electrode; the elastic material is subjected to compressive deformation under the action of pressure, so that the distance between the first electrode and the second electrode can be reduced; when the pressure is higher, the distance between the first electrode and the second electrode is smaller and the capacitance is larger; and when the pressure is lower, the distance between the first electrode and the second electrode is larger and the capacitance is smaller, so that the pressure can be determined by detecting the capacitance.

For instance, the first electrode, the second electrode and the insulating layer in the pressure detection device may be made from a transparent or opaque material. But if the pressure detection device is applied to a display device, the first electrode, the second electrode and the insulating layer in the pressure detection device provided by the embodiment of the present disclosure are all made from transparent materials. For instance, the first electrode and the second electrode are made from transparent conductive materials such as indium tin oxide (ITO).

For instance, the pressure detection device detects the capacitance between the first electrode and the second electrode, so that the shape of the first electrode and the second electrode may be any shape having overlapping sections. For instance, the first electrode is a planar electrode and the second electrode is also a planar electrode; or the first electrode is a strip electrode and the second electrode is a planar electrode.

For instance, the overlapping sections of the first electrode and the second electrode are arranged in a matrix (e.g., a multi-point array). A capacitor is formed at the overlapping section of the first electrode and the second electrode, and the overlapping sections of the first electrode and the second electrode are arranged in a matrix. Thus, when the capacitance between the first electrode and the second electrode is detected, a position applied by pressure (e.g., pressure produced by touch) may also be determined.

The case that relative positions between the first electrode and the second electrode are arranged in a matrix is given below in several examples.

### First Embodiment

For instance, the first electrode includes a plurality of block electrodes arranged in a matrix or an array and insulated from each other (for instance, not contacting with each other), and the second electrode is a planar electrode and corresponds to the first electrode. Or the second electrode includes a plurality of block electrodes arranged in a matrix or an array and insulated from each other (for instance, not contacting with each other), and the first electrode is a planar electrode and corresponds to the second electrode.

For instance, description is given in FIG. 2 by taking the case that the first electrode 11 includes a plurality of block electrodes being arranged in a matrix or an array and not contacting with each other, and the second electrode 12 is a planar electrode and corresponds to the first electrode 11, as an example. As illustrated in FIG. 2, each block electrode in the first electrode has a 2D (x, y) position coordinate (for instance, taking the coordinate of a center position of each block electrode in the first electrode as the position coordinate). Thus, not only the capacitance between the first electrode and the second electrode may be acquired by the capacitance detection module via, for instance, progressive scanning, to determine the pressure, but also the position coordinate of the first electrode may be acquired by the capacitance detection module or other circuit modules to determine the touch position.

Alternatively, for instance, the second electrode includes a plurality of block electrodes being arranged in an array and not contacting with each other, and the first electrode is a planar electrode and corresponds to the second electrode. The specific implementation may refer to the description that the first electrode includes the plurality of block electrodes being arranged in an array and not contacting with each other and the second electrode is a planar electrode. When the second electrode includes a plurality of block electrodes being arranged in an array and not contacting with each other and the first electrode is a planar electrode, the principle of determining the touch position is the same as above. No further redundant description will be given here.

### Second Embodiment

For instance, as illustrated in FIG. 3, the first electrode 11 includes a plurality of strip electrodes arranged in parallel along an x axis (namely in parallel to a y axis), and the second electrode 12 includes a plurality of strip electrodes arranged in parallel along the y axis (namely in parallel to the x axis); the first electrode 11 and the second electrode 12 are partially overlapped; the first electrode 11 and the second electrode 12 are arranged opposite to each other at overlapping sections; and the overlapping sections of the first electrode 11 and the second electrode 12 are arranged in a matrix or a multi-point array. As illustrated in FIG. 3, the first electrode may determine the x-axis coordinate of the touch position, and the second electrode may determine the y-axis coordinate of the touch position. Thus, not only the capacitance between the first electrode and the second electrode can be acquired by the capacitance detection module so as to determine the pressure, but also the touch position can be determined by the capacitance detection module or other circuit modules.

For instance, the overlapping of the first electrode and the second electrode may be that the first electrode 11 and the second electrode 12 are perpendicular to each other as illustrated in FIG. 3, and may also be that the first electrode and the second electrode are overlapped at any included angle (for instance, the included angle is greater than 0).

It should be noted that the description that the overlapping sections of the first electrode and the second electrode are arranged in a matrix or a multi-point array is not limited to the above configuration. Description is given in the embodiment of the present disclosure by only taking the above means as an example.

For instance, the insulating layer includes a plurality of insulating patterns not contacting with each other, and the insulating patterns are disposed at the overlapping sections of the first electrode and the second electrode.

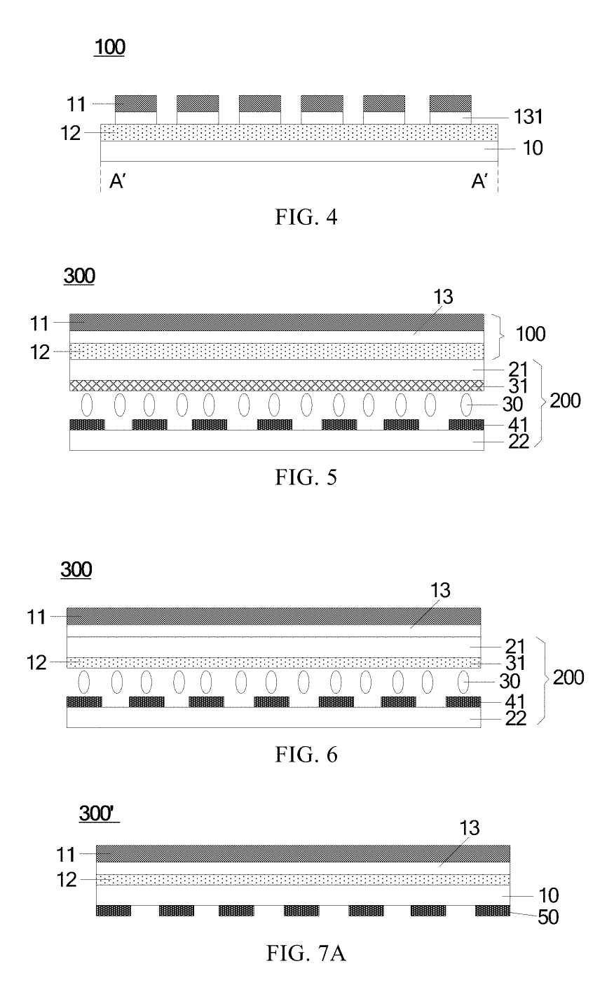

For instance, taking FIG. 2 as an example, compared with the schematic sectional view as illustrated in FIG. 1, the insulating layer in the schematic sectional view as illustrated in FIG. 4 includes insulating patterns 131; the first electrode 11 includes block electrodes being arranged in a matrix or an array and not contacting with each other; the second electrode 12 is a planar electrode; and the insulating patterns 131 are disposed beneath the first electrode 11. For instance, the position beneath the first electrode 11 refers to one side of the first electrode facing the second electrode. Thus, etching characteristics at the edge of the elastic material layer can be eliminated, so that the influence on display can be eliminated.

The embodiment of the present disclosure provides a grating 300, which, as illustrated in FIG. 5, comprises: a grating box 200 and a pressure detection device 100 disposed on the grating box 200.

For instance, the grating 300 not only comprises the grating box 200 and the pressure detection device 100 but also comprises a driving circuit or the like for driving the grating box to form the grating. As the driving circuit or the like for driving the grating box (e.g., liquid crystals in the grating box) are not directly relevant to the present disclosure, the embodiment of the present disclosure only exemplifies the structures relevant to the present disclosure. The capacitance detection module may be integrated on the driving circuit of the grating and may also be independently disposed at another position of the grating. No limitation will be given to the specific position of the capacitance detection module in the embodiment of the present disclosure. Therefore, FIG. 5 only illustrates the hierarchical setting relationship among various layers of electrodes and does not illustrate the capacitance detection module of the pressure detection device.

For instance, the grating provided by the embodiment of the present disclosure not only can form grating fringes but also can detect the pressure, and may also further detect the touch position when the relative positions of the first electrode and the second electrode in the pressure detection device are arranged in a matrix or a multi-point array. The grating may be applied to a 3D display panel. The display device may adjust display parameters according to the pressure applied by the user, and hence improves user experience.

For instance, as illustrated in FIG. 5, the grating box 200 includes: a first substrate 21 and a second substrate 22 which are cell-assembled.

For instance, the first electrode 11, the insulating layer 13 and the second electrode 12 are disposed on one side of the first substrate 21, which side is away from the second substrate 22; a third electrode 31 is disposed on one side of the first substrate 21, which side is close to the second substrate 22; a fourth electrode 41 is disposed on one side of the second substrate 22, which side is close to the first substrate 21; and the grating is formed by the third electrode 31 and the fourth electrode 41. Description is given in FIG. 5 by taking the case that the grating box 200 is a liquid crystal grating as an example. Thus, liquid crystals 30 are also disposed between the third electrode 31 and the fourth electrode 41. The forming principle of the liquid crystal grating is as follows: when a voltage is applied to the third electrode 31 and the fourth electrode 41, the liquid crystals 30 are deflected when driven by the electric field; the deflection angle of the liquid crystals 30 is controlled by controlling the voltage applied to the third electrode 31 and the fourth electrode 41; and hence the grating is formed. Taking the grating box 200 as illustrated in FIG. 5 as an example, when there is no electric field formed between the third electrode 31 and the fourth electrode 41, the grating may be completely transparent. When the voltage is applied to the third electrode 31 and the fourth electrode 41, the liquid crystals 30 at relative positions or overlapping sections of the third electrode 31 and the fourth electrode 41 are deflected and are opaque, and the liquid crystals 30 at positions between two adjacent fourth electrodes 41 are not deflected and are still transparent, so that alternately dark and bright stripes can be formed.

For instance, as illustrated in FIG. 5, the grating is formed by the third electrode 31 and the fourth electrode 41. The third electrode is a strip electrode, and the fourth electrode is a planar electrode and corresponds to a plurality of third electrodes; or the third electrode is a strip electrode, the fourth electrode being a strip electrode, the position of the third electrode corresponding to that of the fourth electrode; or if the third electrode is a planar electrode, the fourth electrode is a strip electrode, and the third electrode corresponds to a plurality of fourth electrodes. That is to say, the third electrode and/or the fourth electrode are a strip electrode, so that the grating can be obtained. Description is given in FIG. 5 by taking the case that the third electrode 31 is a planar electrode and the fourth electrode 41 is a strip electrode as an example.

Alternatively, for instance, as illustrated in FIG. 6, the grating box 200 includes: a first substrate 21 and a second substrate 22 which are cell-assembled.

For instance, the first electrode 11 and the insulating layer 13 are disposed on one side of the first substrate 21, which side is away from the second substrate 22; the second electrode 12 is disposed on one side of the first substrate 21, which side is close to the second substrate 22; a fourth electrode 41 is disposed on one side of the second substrate 22, which side is close to the first substrate 21; and the grating is formed by the second electrode 12 and the fourth electrode 41. Description is given in FIG. 6 by taking the case that the grating box 200 is a liquid crystal grating as an example. Thus, liquid crystals 30 are also disposed between the second electrode 12 and the fourth electrode 41. In the grating as illustrated in FIG. 6, the second electrode 12 not only is used for forming the capacitor with the first electrode 11 to provide convenience for detecting the pressure, but also is used for forming the grating with the fourth electrode 41. Compared with the grating as illustrated in FIG. 5, one layer is reduced, so that the manufacturing process is simplified and the production cost is reduced.

For instance, in the grating as illustrated in FIG. 6, the grating is formed by the second electrode 12 and the fourth electrode 41. The second electrode is a strip electrode, and the fourth electrode is a planar electrode and corresponds to the plurality of second electrodes; or the second electrode is a strip electrode, the fourth electrode being a strip electrode, the position of the second electrode corresponding to that of the fourth electrode; or the second electrode is a planar electrode, the fourth electrode being a planar electrode, the second electrode corresponding to the plurality of fourth electrodes. That is to say, the second electrode and/or the fourth electrode are a strip electrode, so that the grating can be obtained. Description is given in FIG. 6 by only taking the case that the second electrode is planar and the fourth electrode 41 is strip-shaped as an example.

It should be noted that the forming principle of the liquid crystal grating in FIG. 6 is the same as in FIG. 5, so no further description will be given here. Of course, the grating box is not limited to be the liquid crystal grating as illustrated in FIGS. 5 and 6. For instance, the liquid crystals in FIGS. 5 and 6 may also be replaced by an electrochromic material layer. The electrochromic material is transparent at areas or positions without electric field, and is opaque at areas or positions with electric field as the color changes, so that the grating can be formed.

For instance, in FIGS. 5 and 6, the first electrode 11, the second electrode 12 and the insulating layer 13 are all formed on the first substrate 21, so the first substrate 21 is equivalent to the base substrate 10 in FIGS. 1 and 4.

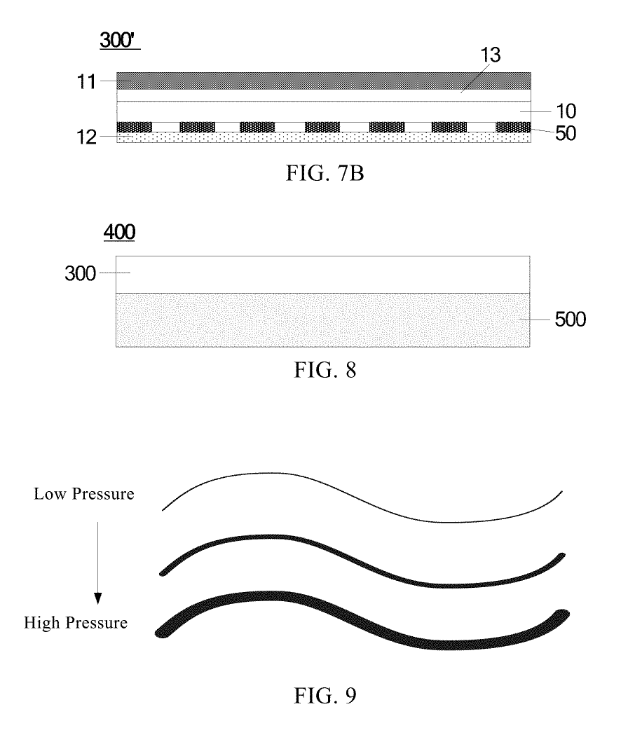

The grating provided by the embodiment of the present disclosure is not limited to the liquid crystal grating and may also be other types of gratings. For instance, as illustrated in FIG. 7A, a grating 300′ comprises a base substrate 10. Grating fringes 50 are formed by forming an opaque material on one side of the base substrate 10, and the opaque material may be a metallic material, a metal oxide material, a resin material, etc. When the pressure detection device provided by the embodiment of the present disclosure is formed on the grating 300′, the pressure detection device and the grating fringes may be formed on different sides of the base substrates. As illustrated in FIG. 7A, the first electrode 11, the second electrode 12 and the insulating layer 13 of the pressure detection device are disposed on the base substrate 10; or as illustrated in FIG. 7B, the first electrode 11 and the insulating layer 13 of the pressure detection device are disposed on a different side of the base substrate 10 from the grating fringes, and the second electrode 12 of the pressure detection device is disposed on the same side of the base substrate as the grating fringes 50.

For instance, the embodiment of the present disclosure provides a display device 400. As illustrated in FIG. 8, the display device 400 comprises a display panel 500 and the grating 300 provided by any embodiment of the present disclosure disposed on a light-emitting side of the display panel 500.

It should be noted that if the grating can detect the pressure but cannot detect the touch position, the display device may further comprise a touch panel for detecting the touch position. If the grating not only can detect the pressure but also can detect the touch position, no touch panel is required to be disposed in the display device.

In the display device provided by the embodiment of the present disclosure, the grating may be used to achieve 3D display and may also further detect the pressure and the touch position. Pressure may be applied in touch. For instance, the color and the saturation of a display frame may be adjusted according to the pressure, or the display scale and the like may be set according to the pressure. Thus, the display effect of the display device can be affected by the pressure applied by the user, so that the user experience can be improved.

The display device not only comprises the grating but also comprises the display panel. The grating is disposed on a display side of the display panel so as to be matched with the display panel to achieve 3D display. For instance, the display panel may be a liquid crystal display (LCD) panel, an organic light-emitting diode (OLED) display panel, an e-paper display panel, etc. When the grating adopts the liquid crystal grating, the display device may conveniently switch between 2D display and 3D display.

For instance, the display device further comprises a circuit bonding pad. The pad is provided with a driver IC or the like for driving the display panel to display. The capacitance detection module of the pressure detection device provided by the embodiment of the present disclosure is, for instance, integrated on the circuit bonding pad.

The embodiment of the present disclosure provides a display method of the display device, which comprises:

S101: acquiring the touch position and the capacitance between the first electrode and the second electrode detected by the capacitance detection module.

The capacitance and the touch position may be acquired by the pressure detection device provided by an embodiment of the present disclosure, or the capacitance of the capacitance detection module may be acquired by the pressure detection device and the touch position may be acquired by the touch panel.

S102: adjusting the display parameter of the display device and/or the sound volume of the display device according to the capacitance and the touch position. For instance, the display parameter may be display brightness, color, color saturation, display scale, etc. For instance, the color of a display frame may be adjusted according to pressure. Thus, the display effect of the display device can be affected by the pressure applied by the user, so that the user experience can be improved.

For instance, when the display device is applied in operations such as drawing, the touch position and the pressure can affect the drawing effect. As illustrated in FIG. 9, the pen may be set to be thinner when the pressure is lower and be thicker when the pressure is higher.

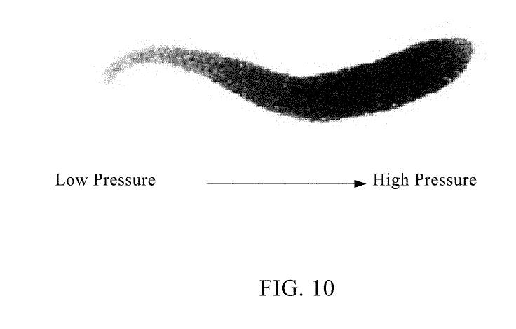

For instance, in the process of forming a touch path, the capacitance between the first electrode and the second electrode at each touch position on the touch path is acquired, and the pen size corresponding to the touch position is adjusted according to the capacitance at the touch position. Description is given by taking the case that the display device is a drawing board as an example. When a user utilizes the display device for handwriting practice, the stroke thickness may be adjusted by controlling the pressure. As illustrated in FIG. 10, the stroke is thicker when the pressure is increased from left to right. Alternatively, in the process of handwriting practice, as illustrated in FIG. 10, the ink density is higher when the pressure is increased from left to right. Thus, the handwriting practice of the user on the display device is closer to actual writing practice, so that the user experience can be improved.

The foregoing is only the preferred embodiments of the present disclosure and not intended to limit the scope of protection of the present disclosure. All the changes or replacements which may be easily thought of by those skilled in the art within the technical scope disclosed by the present disclosure shall fall within the scope of protection of the present disclosure. Therefore, the scope of protection of the present disclosure shall be defined by the appended claims.

The application claims priority to the Chinese patent application No. 201510729202.4, filed Oct. 30, 2015, the entire disclosure of which is incorporated herein by reference as part of the present application.

1. A pressure detection device, comprising: a capacitance detection module, a first electrode, a second electrode and an insulating layer, wherein the insulating layer is made from an elastic material and disposed between the first electrode and the second electrode;
the first electrode and the second electrode are at least partially overlapped; and the capacitance detection module is respectively connected with the first electrode and the second electrode and configured to detect capacitance between the first electrode and the second electrode.

2. The pressure detection device according to claim 1, wherein the first electrode and the second electrode are overlapped at a plurality of overlapping sections, and the overlapping sections are arranged in a matrix.

3. The pressure detection device according to claim 1, wherein the first electrode includes a plurality of block electrodes arranged in a matrix and insulated from each other, and the second electrode is a planar electrode and corresponds to the first electrode; or
the second electrode includes a plurality of block electrodes arranged in a matrix and insulated from each other, and the first electrode is a planar electrode and corresponds to the second electrode; or
the first electrode includes a plurality of strip electrodes arranged in parallel to each other; the second electrode includes a plurality of strip electrodes arranged in parallel to each other; and the plurality of strip electrodes in the first electrode and the plurality of strip electrodes in the second electrodes are partially overlapped.

4. The pressure detection device according to claim 1, wherein the insulating layer includes a plurality of insulating patterns separate from each other; and the insulating patterns are disposed at the overlapping sections of the first electrode and the second electrode.

5. A grating, comprising: the pressure detection device according to claim 1.

6. The grating according to claim 5, further comprising: a base substrate provided with grating fringes,
wherein the pressure detection device is disposed on the base substrate and disposed on a same side of the base substrate as the grating fringes or on a different side of the base substrate from the grating fringes.

7. The grating according to claim 5, further comprising: a grating box, wherein the pressure detection device is disposed on the grating box.

8. The grating according to claim 7, wherein the grating box includes: a first substrate and a second substrate which are cell-assembled;
the first electrode, the insulating layer and the second electrode are disposed on one side of the first substrate away from the second substrate; a third electrode is disposed on one side of the first substrate close to the second substrate; a fourth electrode is disposed on one side of the second substrate close to the first substrate; and the grating is formed by the third electrode and the fourth electrode.

9. The grating according to claim 7, wherein the grating box includes: a first substrate and a second substrate which are cell-assembled;
the first electrode and the insulating layer are disposed on one side of the first substrate away from the second substrate; the second electrode is disposed on one side of the first substrate close to the second substrate; a fourth electrode is disposed on one side of the second substrate close to the first substrate; and the grating is formed by the second electrode and the fourth electrode.

10. The grating according to claim 9, wherein
the second electrode is a strip electrode, and the fourth electrode is a planar electrode and corresponds to the plurality of second electrodes; or
the second electrode is a strip electrode, the fourth electrode being a strip electrode, the second electrode corresponding to the fourth electrode; or
the second electrode is a planar electrode, the fourth electrode being a strip electrode, the second electrode corresponding to the plurality of fourth electrodes.

11. A display device, comprising a display panel and the grating according to claim 5 disposed on a light-emitting side of the display panel.

12. A display method of a display device, comprising:
acquiring a touch position and capacitance between a first electrode and a second electrode detected by a capacitance detection module; and
adjusting a display parameter of the display device and/or a sound volume of the display device according to the capacitance and the touch position.

13. The display method according to claim 12, wherein in a process of forming a touch path, the capacitance between the first electrode and the second electrode at each touch position on the touch path is acquired, and a pen size corresponding to the touch position is adjusted according to the capacitance at the touch position.

14. The display method according to claim 12, wherein the capacitance detection module detects the capacitance and the touch position by detecting a capacitance variation between the first electrode and the second electrode caused by decrease or increase of the relative distance.
